(19) United States
(12) Patent Application Publication
(10) Pub. No.: US 2025/0151021 A1
(43) Pub. Date: May 8, 2025

(54) RELAXED POSITIONING FOR POWER SAVING IN WIRELESS COMMUNICATIONS

(71) Applicant: ZTE Corporation, Shenzhen (CN)

(72) Inventors: Yu PAN, Shenzhen (CN); Chuangxin JIANG, Shenzhen (CN); Jing LIU, Shenzhen (CN); Cong WANG, Shenzhen (CN); Mengzhen LI, Shenzhen (CN)

(73) Assignee: ZTE Corporation, Shenzhen (CN)

(21) Appl. No.: 19/020,311

(22) Filed: Jan. 14, 2025

Related U.S. Application Data
(63) Continuation of application No. PCT/CN2023/073000, filed on Jan. 18, 2023.

(51) Int. Cl. H04W 64/00; H04L 5/00; H04W 24/10

(52) U.S. Cl. CPC H04W 64/00; H04L 5/0051; H04W 24/10

(57) ABSTRACT

This document generally relates to wireless communication that includes a user device that determines that it satisfies a condition, and in response to satisfying the condition, performs at least one of: a relaxed positioning reference signal (PRS) measurement according to a relaxed PRS measurement rule that corresponds to the condition; or a relaxed sounding reference signal (SRS) transmission according to a relaxed SRS transmission rule that corresponds to the condition. Additionally, at least one network device determines a relaxed PRS measurement rule corresponding to a first condition or a relaxed SRS transmission rule corresponding to a second condition. The at least one network device transmits the relaxed PRS measurement rule corresponding to the first condition or the relaxed SRS transmission rule corresponding to the second condition.

### CROSS-REFERENCE TO RELATED APPLICATION(S)

The present application is a continuation of International Patent Application No. PCT/CN2023/073000, filed Jan. 18, 2023. The contents of International Patent Application No. PCT/CN2023/073000 are herein incorporated by reference in their entirety.

### TECHNICAL FIELD

This document is directed generally to relaxed positioning reference signal (PRS) and relaxed sounding reference signal (SRS) rules for wireless communication.

### BACKGROUND

A low power high accuracy positioning (LPHAP) user device may reduce power consumption when performing high accuracy positioning, especially in a RRC_INACTIVE and RRC_IDLE states. A user device may wake up to receive every positioning reference signal (PRS) indicated by a location management function (LMF) when in the RRC_INACTIVE or RRC_IDLE state, and may send a sounding reference signal (SRS) as configured by the network, which may cause large ramp-up and/or ramp-down power consumption. Ways to reduce such power consumption may be desirable.

### SUMMARY

This document relates to methods, systems, apparatuses and devices for wireless communication. In some implementations, a method for wireless communication includes: determining, by a user device, that the user device satisfies a condition; and in response to satisfying the condition, at least one of: performing, by the user device, a relaxed positioning reference signal (PRS) measurement according to a relaxed PRS measurement rule that corresponds to the condition; or performing, by the user device, a relaxed sounding reference signal (SRS) transmission according to a relaxed SRS transmission rule that corresponds to the condition.

In some other implementations, a method for wireless communication includes: determining, by at least one network device, a relaxed positioning reference signal (PRS) measurement rule corresponding to a first condition or a relaxed sounding reference signal (SRS) transmission rule corresponding to a second condition, wherein the relaxed PRS measurement rule comprises a relaxed PRS configuration and the relaxed SRS transmission rule comprises a relaxed SRS configuration; and transmitting, by the at least one network device, the relaxed PRS measurement rule corresponding to the first condition or the relaxed SRS transmission rule corresponding to the second condition, wherein the at least one network device comprises at least one of a location management function (LMF) or one or more radio access network (RAN) nodes.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a wireless access node of the wireless communication system of FIG. 1.

FIG. 3 shows a flow chart of an example method for wireless communication.

FIG. 4 shows a flow chart of another example method for wireless communication.

FIG. 5 shows a timing diagram illustrating an example of a synchronization signal block (SSB) and a positioning reference signal (PRS) reception window overlapping.

### DETAILED DESCRIPTION

The present description describes various embodiments of systems, apparatuses, devices, and methods for wireless communications that relates to a relaxed positioning reference signal (PRS) measurement rule and a relaxed sounding reference signal (SRS) measurement rule.

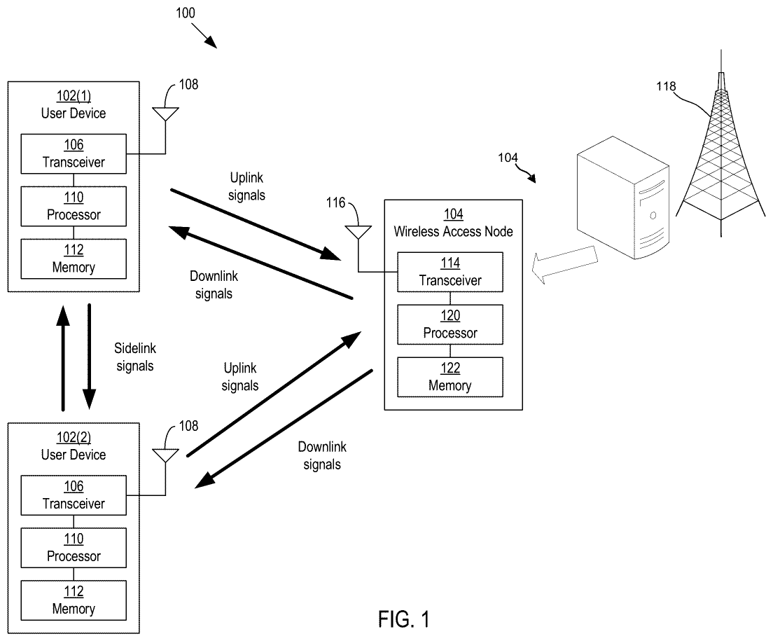

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include at least one device, electronic and/or network device or apparatus, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

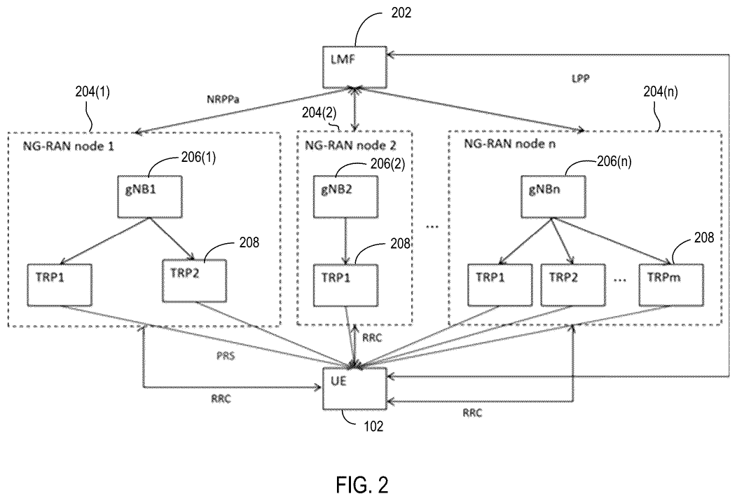

FIG. 2 shows a block diagram of an example configuration of a wireless access node 104. In the example configuration, the wireless access node 104 may include a location management function (LMF) 202 and one or more radio access network (RAN) nodes 204. Some embodiments may include only one RAN node 204. Other embodiments, such as shown in FIG. 2, may include a plurality, or an n-number, of RAN nodes 204(1) to 204(n), where n is two or more. Additionally, each component of the wireless access node 104, such as the LMF 202 and each RAN node 204, may include at least one network device, and/or may be configured in hardware or a combination of hardware and software, such as by having a processor 120, a memory 122, transceiver circuitry 114, an antenna 116, and/or an antenna tower 118, such as shown in FIG. 1 for the wireless access node 104.

Additionally, as shown in FIG. 2, the LMF 202 and each of the RAN nodes 204 may be configured to communicate (transmit and receive) with each other, such as signals or messages, and may be configured to communicate (transmit and receive) with one or more user device 102, either directly or indirectly via another component of the wireless access node 104. For example, the LMF 202 may directly communicate with a user device 102. In particular embodiments, the LMF 202 may directly communicate with a user device 102 according to a Long-Term Evolution (LTE) positioning protocol (LPP) (i.e., via LPP signaling). Also, a RAN node 204 may directly communicate with a user device 102. In particular embodiments, a RAN node 204 may directly communicate with a user device 102 at least via radio resource control (RRC) signaling. In addition, the LMF 202 may directly communicate with each RAN node 204. In particular embodiments, the LMF 202 may directly communicate with each RAN node 204 according to New Radio Positioning Protocol A (NRPPa) (i.e., via NRPPa signaling). Also, for at least some embodiments, such as shown in FIG. 2, each RAN node 204 may include one or more sub-components. For example, a RAN node 204 may include a gNB and/or at least one transmission/reception point (TRP) 208. Further functionality of the LMF 202 and the RAN nodes 204 is described in further detail below.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Also, in some embodiments, a user device 102 may receive and/or measure a synchronization signal block (SSB) from a serving cell and/or a neighbor cell in a radio resource control (RRC) inactive state (e.g., RRC_INACTIVE) and/or a RRC idle state (e.g., RRC_IDLE) for a radio resource management (RRM) measurement. In various embodiments, the SSB may be configured to be measured in a period, called a SSB measurement timing configuration (SMTC). In some embodiments, in event that the user device satisfies some condition, the user device 102 may perform a relaxed RRM measurement via a reduced SSB measurement.

Also, in some embodiments, when a positioning service triggers, a user device 102 may be scheduled to receive a positioning reference signal (PRS) in the RRC inactive state (e.g., RRC_INACTIVE) and/or in the RRC idle state (e.g., RRC_IDLE), and/or the user device 102 may send a sounding reference signal (SRS) in the RRC inactive state (e.g., RRC_INACTIVE) and/or in the RRC idle state (e.g., RRC_IDLE). In some embodiments, each time the user device 102 receives a PRS, a SSB, a DCI, and/or a PDSCH, and/or each time the user device 102 sends a SRS, the user device 102 may wake up from a sleep mode (e.g., deep sleep, light sleep or ultra sleep mode) to an active mode.

Further, in at least some embodiments of positioning, a PRS is sent by a serving TRP 208 and/or one or more neighbor TRPs 208. However, a PRS configuration of all the TRPs 208 is sent by the LMF 202. Additionally, in some embodiments, at least some capability of the user device 102 is reported to the serving gNB 206 via RRC signaling, and/or at least some of the capability of the user device 102 is reported to the LMF 202 via LTE positioning protocol (LPP) signaling. The user device 102 may report its measurement result of PRS related measurements to the LMF 202 via LPP signaling.

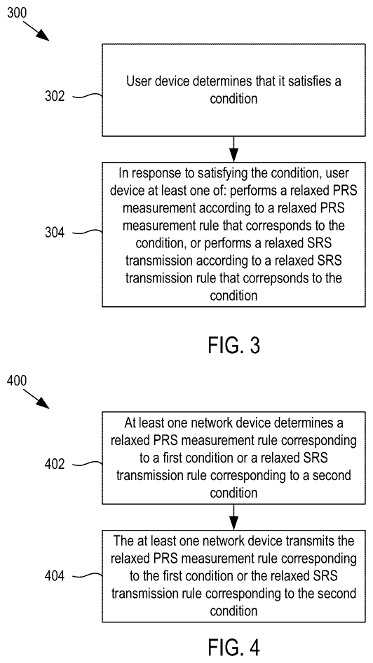

FIG. 3 shows a flow chart of an example method 300 for wireless communication that involves a relaxed positioning reference signal (PRS) measurement rule and/or a relaxed sounding reference signal (SRS) transmission rule. At block 302, a user device 102 may determine that it satisfies a condition. At block 304, in response to satisfying the condition, the user device may at least one of: perform a relaxed positioning reference signal (PRS) measurement according to a relaxed PRS measurement rule that corresponds to the condition, or perform a relaxed sounding reference signal (SRS) transmission according to a relaxed SRS transmission rule that corresponds to the condition.

FIG. 4 shows a flow chart of another example method 400 for wireless communication that involves a PRS measurement rule and/or a relaxed SRS transmission rule. At block 402, at least one network device may determine a relaxed PRS measurement rule corresponding to a first condition or a relaxed SRS transmission rule corresponding to a second condition. The relaxed PRS measurement rule may include a relaxed PRS configuration, and/or the relaxed SRS transmission rule may include a relaxed SRS configuration. At block 404, the at least one network device may transmit the relaxed PRS measurement rule corresponding to the first condition or the relaxed SRS transmission rule corresponding to the second condition. Also, the at least one network device may include at least one of the LMF 202 or one or more RAN nodes 204.

Additionally, in any of various embodiments of the method 300 and/or the method 400, the user device 102 may be in a RRC connected state (e.g., RRC_CONNECTED), an RRC inactive state (e.g., RRC_INACTIVE), a RRC idle state (e.g., RRC_IDLE), a connection management (CM) state (e.g., CM_CONNECTED), or a CM idle state (e.g., CM_IDLE). In addition or alternatively, in any of various embodiments of the method 300 and/or the method 400, the user device 102 may be a LPHAP user device, a RedCap user device, or a normal user device (i.e., no dedicated UE identification, with separate UE capabilities reported to the network).

Additionally, in some embodiments of the method 300 and/or the method 400, the relaxed PRS measurement rule includes a relaxed PRS configuration configured by at least one network device, wherein the relaxed PRS configuration is received by the user device 102 in at least one of a broadcast signaling or a signaling dedicated for the user device 102.

Additionally, in some embodiments of the method 300 and/or the method 400, the relaxed PRS measurement rule includes a relaxed PRS configuration that is predefined.

Additionally, in some embodiments of the method 300 and/or the method 400, the relaxed SRS transmission rule includes a relaxed SRS configuration configured by at least one network device, wherein the relaxed SRS configuration is received by the user device 102 in a broadcast signaling or a signaling dedicated for the user device 102.

Additionally, in some embodiments of the method 300 and/or 400, the relaxed SRS transmission rule includes a relaxed SRS configuration that is pre-defined.

Additionally, in some embodiments of the method 300 and/or the method 400, the user device 102 may perform at least one of the relaxed PRS measurement or the relaxed SRS transmission within a first time period.

Additionally, in some embodiments of the method 300 and/or the method 400, the user device 102 may perform at least one of the relaxed PRS measurement or the relaxed SRS transmission within a first validity area. In some of these embodiments, the first validity area includes at least one of: a list of cells or a list of transmission reception points (TRPs 208).

Additionally, in some embodiments of the method 300 and/or the method 400, the user device 102 may transmit, to at least one network device, at least one of: an indication that the user device has satisfied the condition or the condition that the user device satisfies.

Additionally, in some embodiments of the method 300 and/or the method 400, the user the condition, the first condition, and/or the second condition, may include at least one of: low mobility criteria, UE-not-at-cell-edge criteria, stationary criteria, stationary not-at-cell-edge criteria, the user device is in a signal intensity level, the user device supports the relaxed PRS measurement, the user device supports the relaxed SRS transmission, the user device is in a radio resource control (RRC) inactive state, or the user device is in a RRC idle state.

Additionally, in some embodiments of the method 300 and/or the method 400, low mobility criteria is configured for a radio resource management (RRM) relaxed measurement, the method further comprising, and the user device 102 may use the low mobility criteria in order to determine whether to perform at least one of: the relaxed PRS measurement or the relaxed SRS transmission. In some of these embodiments, the user device 102 may receive one or more parameters of the low mobility criteria dedicated for at least one of the relaxed PRS measurement or the relaxed SRS transmission from at least one network device.

Additionally, in some embodiments of the method 300 and/or the method 400, UE-not-at-cell-edge criteria is configured for a radio resource management (RRM) relaxed measurement, and the user device 102 may use the UE-not-at-cell-edge criteria in order to determine whether to perform at least one of: the relaxed PRS measurement or the relaxed SRS transmission. In some of these embodiments, the user device 102 may receive one or more parameters of the UE-not-at-cell-edge criteria dedicated for at least one of the relaxed PRS measurement or the relaxed SRS transmission from at least one network device.

Additionally, in some embodiments of the method 300 and/or the method 400, the user device 102 may perform at least one of the relaxed PRS measurement or the relaxed SRS transmission according to a combined indication for low mobility criteria and UE-not-at-cell-edge criteria that is used for a radio resource management (RRM) relaxed measurement. For example, in some embodiments, the combined indication may be, and/or may be set to, a certain or predetermined value (e.g., a value corresponding to Boolean TRUE), the user device 102 may perform at least one of the relaxed PRS measurement or the relaxed SRS transmission when both the low mobility criteria and the UE-not-at-cell-edge criteria that are used for a radio resource management (RRM) relaxed measurement are satisfied.

Additionally, in some embodiments of the method 300 and/or the method 400, the user device 102 may receive an indication dedicated for at least one: the relaxed PRS measurement or the relaxed SRS transmission, where the indication is included in a broadcast signaling or a signaling dedicated for the user device. In response to receipt of the indication, the user device 102 may determine to perform at least one of the relaxed PRS measurement or the relaxed SRS transmission only when both the low mobility criteria and the UE-not-at-cell-edge criteria are satisfied.

Additionally, in some embodiments of the method 300 and/or the method 400, stationary criteria and stationary not-at-cell-edge criteria are configured for a reduced capability (RedCap) user device, and the user device 102 may use at least one of the stationary criteria or the stationary not-at-cell-edge criteria in order to determine whether to perform at least one of: the relaxed PRS measurement or the relaxed SRS transmission.

Additionally, in some embodiments of the method 300 and/or the method 400, the usr device 102 may determine that the user device is in a signal intensity level by comparing a PRS measurement of a cell or a transmission reception point (TRP) 208 with a predefined signal intensity level. The PRS measurement of the cell or the TRP 208 may be determined by the weighted average of one or more PRS measurements, and/or the one or more PRS measurements may be determined by measuring one or more PRS samples of one or more PRS resources within the cell or the TRP 208, for example, the same or different weight value is multiplied to the one or more PRS measurements before they are averaged. For at least some of these embodiments, the one or more PRS samples is determined within a second time period.

Additionally, in some embodiments of the method 300 and/or the method 400, the relaxed PRS configuration includes at least one of: a plurality of PRS resources; a plurality of PRS resource sets; a plurality of PRS resources that is within a plurality of transmission reception points (TRPs) 208; a plurality of PRS resources that is within a plurality of cells; a plurality of PRS resources that is within a plurality of PRS frequency layers; a plurality of PRS resources that is within a selected PRS reception window; a plurality of PRS resources comprising a PRS symbol that is decreased; a plurality of PRS resources comprising a PRS bandwidth that is decreased; a plurality of PRS resources comprising a PRS comb size that is increased; a plurality of PRS resources comprising a PRS periodicity that is increased; or a plurality of PRS resources comprising a PRS repetition factor that is decreased.

Additionally, in some embodiments of the method 300 and/or the method 400, the relaxed SRS configuration includes at least one of: a plurality of SRS resource sets; a plurality of SRS resources; a plurality of SRS resources comprising a SRS periodicity that is increased; a plurality of SRS resources that is within a SRS second validity area, wherein the SRS second validity area is dedicated for the relaxed SRS transmission; or a plurality of SRS resources comprising a SRS transmission power that is decreased.

Additionally, in some embodiments of the method 300 and/or the method 400, the user device 102 may receive a request to report the condition, the first condition, and/or the second condition that the user device satisfies.

Additionally, in some embodiments of the method 300 and/or the method 400, the user device 102 may transmit a request to receive at least one of the relaxed PRS configuration or the relaxed SRS configuration.

Additionally, in some embodiments of the method 300 and/or the method 400, the user device 102 may receive at least one indication to trigger the user device 102 to perform at least one of the relaxed PRS measurement according to the relaxed PRS measurement rule or the relaxed SRS transmission according to the relaxed SRS transmission rule.

Additionally, in some embodiments of the method 300 and/or the method 400, the user device 102 may transmit a report of a capability of the user device 102 to support a judgment of the condition, the first condition, and/or the second condition. For at least some of these embodiments, the report of the capability to support a judgement of the condition, the first condition or the second condition may include a report of a capability of the user device 102 to determine whether it satisfies the condition, the first condition, or the second condition.

Additionally, in some embodiments of the method 300 and/or the method 400, the user device 102 may transmit a report of a capability of the user device 102 to perform at least one of: the relaxed PRS measurement according to the relaxed PRS measurement rule or the relaxed SRS transmission according to the relaxed SRS transmission rule.

Additionally, in some embodiments of the method 300 and/or the method 400, in response to another condition, the user device 102 may measure a synchronization signal block (SSB) only during a third time period that a corresponding SSB measurement timing configuration (SMTC) and a PRS reception window overlap. In particular of these embodiments, the another condition may include at least one of: low mobility criteria; UE-not-at-cell-edge criteria; the user device supports a radio resource management (RRM) relaxed measurement; the user device is in a radio resource control (RRC) inactive state; or the user device is in a RRC idle state.

Additionally, in some embodiments of the method 300 and/or the method 400, the at least one network device may configure a first time period during which the user device 102 is to perform at least one of a relaxed PRS measurement according to the relaxed PRS measurement rule or a relaxed SRS transmission according to the relaxed SRS transmission rule.

Additionally, in some embodiments of the method 300 and/or the method 400, the at least one network device may configure a first validity area in which the user device 102 is to perform at least one of a relaxed PRS measurement according to the relaxed PRS measurement rule or a relaxed SRS transmission according to the relaxed SRS transmission rule. In some of these embodiments, the first validity area includes at least one of: a list of cells or a list of transmission reception points (TRPs) 208.

Additionally, in some of embodiments of the method 300 and/or the method 400, the at least one network device may receive at least one of: an indication that the user device 102 has satisfied the condition, the first condition, or the second condition; or condition, the first condition, or the second condition that the user device satisfies.

Additionally, in some embodiments of the method 300 and/or the method 400, the at least one network device may determine one or more parameters of low mobility criteria dedicated for the user device 102 to perform at least one of the relaxed PRS measurement or the relaxed SRS transmission. Additionally, the at least one network device 102 may transmit the one or more parameters to the user device 102.

Additionally, in some embodiments of the method 300 and/or the method 400, the at least one network device may determine one or more parameters of UE-not-at-cell-edge criteria for the user device 102 to perform at least one of the relaxed PRS measurement or the relaxed SRS transmission. Additionally, the at least one network device may transmit the one or more parameters to the user device.

Additionally, in some embodiments of the method 300 and/or the method 400, the at least one network device may determine an indication dedicated for the user device 102 to perform at least one of the relaxed PRS measurement or the relaxed SRS transmission. Additionally, the at least one network device may transmit the indication to indicate the user device 102 to perform at least one of the relaxed PRS measurement or the relaxed SRS transmission only when both the low mobility criteria and the UE-not-at-cell-edge criteria are satisfied.

Additionally, in some embodiments of the method 300 and/or the method 400, the LMF 202 may request the one or more RAN nodes 204 to trigger the user device 102 to perform at least one of the relaxed PRS measurement or the relaxed SRS transmission.

Additionally, in some embodiments of the method 300 and/or the method 400, the at least one network device may request the user device 102 to perform at least one of the relaxed PRS measurement or the relaxed SRS transmission.

Additionally, in some embodiments of the method 300 and/or the method 400, the LMF 202 may request the one or more RAN nodes 204 to at least one of provide or update the relaxed PRS configuration or relaxed SRS configuration.

Additionally, in some embodiments of the method 300 and/or the method 400, the one or more RAN nodes 204 may provide to the LMF 202 at least one of the relaxed PRS configuration or relaxed SRS configuration.

Additionally, in some embodiments of the method 300 and/or the method 400, the at least one network device may request to the user device 102 to provide the condition, the first condition, or the second condition that the user device satisfies.

Additionally, in some embodiments of the method 300 and/or the method 400, the at least one network device may receive, from the user device 102, a request to receive at least one of the relaxed PRS configuration or the relaxed SRS configuration.

Additionally, in some embodiments of the method 300 and/or the method 400, the at least one network device may receive, from the user device 102, a report of a capability of the user device to support a judgment of the condition, the first condition, or the second condition. For at least some of these embodiments, the report of the capability to support a judgement of the condition, the first condition or the second condition may include a report of a capability of the user device 102 to determine whether it satisfies the condition, the first condition, or the second condition.

Additionally, in some embodiments of the method 300 and/or the method 400, the at least one network device may receive, from the user device 102, a report of a capability of the user device to support performing at least one of the relaxed PRS measurement according to the relaxed PRS measurement rule or the relaxed SRS transmission according to the relaxed SRS transmission rule.

Further details of the method 300 and/or the method 400 are now described.

In some embodiments, in event that the user device 102 satisfies a condition, the user device 102 may perform a relaxed PRS measurement according to a relaxed PRS measurement rule. In some of these embodiments, the relaxed PRS measurement rule may include at least one relaxed PRS configuration configured from the LMF 202 or gNB 206 (via at least one of dedicated LPP or RRC signaling, or via RRC broadcast signaling). In other embodiments, the relaxed PRS measurement rule may be part of a specification or standard, such as in the form of a pre-defined relax rule, according to which the user device 102 is configured to operate or follow.

In addition or alternatively, at least one network device, such as the LMF 202 and/or a gNB 206, may configure different relaxed PRS configurations corresponding to different conditions. If a user device 102 satisfies a condition, the user device 102 may adopt a relaxed PRS configuration that corresponds to the condition, and may perform relaxed PRS measurements.

Additionally, for at least some embodiments, at least one network device, such as the LMF 202 and/or a gNB 206, may configure a timer or time duration associated with a condition. In event a user device 102 satisfies the condition before the time expires or within the time duration, the user device 102 may adopt the corresponding relaxed PRS configuration, and may perform relaxed positioning measurements. In other embodiments, the timer and/or time duration may be pre-defined, instead of the at least one network device configuring the time or time duration, such as via explicit signaling. In addition or alternatively, the at least one network device, such as the LMF 202 and/or gNB 206, may further configure a validity area associated with the condition. In event that the user device 102 satisfies the condition within the validity area, the user device 102 may adopt the corresponding relaxed PRS configuration, and may perform relaxed positioning measurements. For at least some embodiments, a validity area may include a list of cells or a list of TRPs. In addition or alternatively, a validity area configured for latency enhancement may be reused for the validity area in which the user device 102 may satisfy the condition.

In addition or alternatively, in some embodiments, the user device 102 may report a condition that it satisfies to the at least one network device (e.g., a gNB 206 and/or the LMF 202). The, or in response, the at least one network device (e.g., the LMF 202 and/or gNB 206) may send the corresponding relaxed PRS configuration to the user device 102. In turn, the user device 102 may adopt the corresponding relaxed PRS configuration, and perform relaxed positioning measurements. In some of these embodiments, the user device 102 may be configured with a timer or time duration and/or a validity area from the at least one network device. In turn, the user device 102 may monitor the condition during the timer/time duration and/or in the validity area. Additionally, in some embodiments, the timer/time duration may be pre-defined or preconfigured, such that explicit signaling may not be used to configure the user device 102 with the timer or time duration. For at least some of these embodiments, the user device 102 may further report a timer or time duration associated with a condition. The at least one network device may determine that the user device 102 satisfies the condition until the timer or time duration ends. In addition or alternatively, the user device 102 may report a validity area associated with a condition. The at least one network device may determine that the user device 102 is to satisfy the condition within the validity area. For at least some embodiments, a validity area may include a list of cells or a list of TRPs 208.

In addition or alternatively, in some embodiments, if a user device 102 satisfies a condition, the user device 102 may perform relaxed PRS measurements according to one or more pre-defined relax rules. A pre-defined relax rules may be a rule included in a standard or specification according to which the communication nodes communicate in the wireless communication network 100. In addition or alternatively, a pre-defined relax rule may include at least one relaxed PRS configuration that the user device 102 is to adopt. Different conditions may correspond to different pre-defined relax rules. In addition or alternatively, a pre-defined relax rule may be associated with a timer or time duration during which the user device 102 is to perform the relaxed positioning measurement. In addition or alternatively, the pre-defined relax rules may be associated with a validity area in which the user device 102 is to perform the relaxed positioning measurement. For at least some embodiments, a validity area may include a list of cells or a list of TRPs 208.

In addition, for at least some embodiments, a condition that the user device 102 may satisfy may include at least one of (e.g., a single one of or a combination of two or more of) the following: low mobility criteria; UE-not-at-cell-edge criteria; medium-mobility state criteria; normal-mobility state criteria; stationary criteria; stationary not-at-cell-edge criteria; the user device is in a certain signal intensity level; the user device is a low power high accuracy positioning (LPHAP) user device; the user device 102 supports the relaxed PRS configuration; the user device 102 supports the relaxed PRS measurement; the user device 102 is in radio resource control (RRC) inactive state (e.g., RRC_INACTIVE); the user device 102 is in a RRC idle state (e.g., RRC_IDLE); or the user device is in a RRC connected state (e.g., RRC_CONNECTED). Accordingly, non-limiting example conditions that a user device 102 may judge to be satisfied include: the user device 102 satisfies low mobility criteria but not UE-not-at-cell-edge criteria; the user device 102 satisfies UE-not-at-cell-edge criteria but not low mobility criteria; the user device 102 satisfies low mobility criteria and UE-not-at-cell-edge criteria; the user device 102 does not satisfy low mobility criteria and UE-not-at-cell-edge criteria; the user device 102 satisfies the low mobility criteria and further satisfies a certain signal intensity level; the user device 102 satisfies the UE-not-at-cell-edge criteria and further satisfies a certain signal intensity level; the user device 102 satisfies the low mobility criteria and the UE-not-at-cell-edge criteria, and further satisfies a certain signal intensity level.

Additionally, in some embodiments, a user device 102 may “reuse” a condition for a relaxed PRS measurement or a relaxed SRS transmission that it uses for another action or event, such as a radio resource management (RRM) relaxed measurement for example. In event that the user device 102 determines that the condition for the other action or event is satisfied, then the user device 102 may “reuse” that condition for the relaxed PRS measurement and/or the relaxed SRS transmission, such as by adopting the corresponding relaxed PRS configured and/or the relaxed SRS configuration that corresponds to the condition. Various embodiments of a user device 102 “reusing” a condition are described in further detail below.

In addition or alternatively, a user device 102 may reuse the low mobility criteria configured for a radio resource management (RRM) relax measurement in system information block type 2 (SIB2), in order to determine whether it should perform a relaxed positioning measurement. For at least some embodiments, a gNB 206 may configure a lowMobilityEvaluation including s-SearchDeltaP and t-SearchDeltaP, and the relaxed measurement criterion for the user device 102 with low mobility is fulfilled when:

```
- (Srxlev_{Ref} - Srxlev) < S_{SearchDeltaP},
Where:
- Srxlev = current Srxlev value of the serving cell (dB).
- SrxlevRef = reference Srxlev value of the serving cell (dB), set as follows:
          - After selecting or reselecting a new cell, or
          - If (Srxlev - Srxlev_{Ref}) > 0, or
          - If the relaxed measurement criterion has not been met for T_{SearchDeltaP}:
          - The UE shall set the value of Srxlev_{Ref} to the current Srxlev value of the serving
cell.
Srxlev_{Ref} and Srxlev may be measured based on the SSB or the PRS.
```

In other embodiments, the at least one network device (e.g., a gNB 206) may configures parameters of low mobility criteria dedicated for a relaxed positioning measurement and notify the user device 102 in the broadcast or dedicated signaling. The broadcast signaling can be a positioning system information block (SIB) or normal SIB (such as SIB2/3/4, etc). Also, the dedicate signaling can be a RRC Release or a RRC

Reconfiguration message. In particular, the at least one network device (e.g., a gNB 206) may configure threshold A (similar as s-SearchDeltaP) for the relaxed positioning measurement and a threshold B (similar as t-SearchDeltaP) the for relaxed positioning measurement. The judgment rule may be the same as previously described.

In addition or alternatively, the user device 102 may reuse the UE-not-at-cell-edge criteria configured for a RRM relax measurement in SIB2, in order to determine whether it should perform the relaxed positioning measurement. In particular of these embodiments, the at least one network device (e.g., a gNB 206) may configure cellEdgeEvaluation including s-SearchThresholdP and s-SearchThresholdQ, and the relaxed measurement criterion for the UE-not-at-cell-edge may be fulfilled when:

- Srxlev > S_{SearchThresholdP}, and,
- Squal > S_{SearchThresholdQ}, if S_{SearchThresholdQ} is configured,
Where:
- Srxlev = current Srxlev value of the serving cell (dB).
- Squal = current Squal value of the serving cell (dB).
Squal and Srxlev may be measured based on SSB or PRS.

In other embodiments, the at least one network device (e.g., gNB 206) may configure parameters of the UE-not-at-cell-edge criteria dedicated for the relaxed positioning measurement and the notify the user device 102 in the broadcast or dedicate signaling. For at least some embodiments, the broadcast signaling may be a positioning SIB or a normal SIB (such as SIB2/3/4, etc). Additionally, the dedicated signaling can be a RRC Release or a RRC Reconfiguration message. In particular embodiments, the at least one network device (e.g., gNB 206) may configure a threshold C (similar as s-SearchThresholdP) for the relaxed positioning measurement and a threshold D (similar as s-SearchThresholdQ) for the relaxed positioning measurement. The judgment rule may be the same as previously described.

In addition or alternatively, the user device 102 may reuse a combined indication (e.g, a combineRelaxedMeasCondition indication in SIB2) that is used for RRM relax measurement in the relaxed positioning measurement. The combined indication may configure the user device 102 to fulfill both the low mobility criteria and the UE-not-at-cell-edge criteria in order to satisfy the relax measurement requirements for cell reselection. If the combined indication is, and/or is set to, a certain value (e.g., a value corresponding to Boolean TRUE), the user device 102 may perform the relaxed positioning measurement when both the UE-not-at-cell-edge and the low mobility criteria are satisfied.

In addition or alternatively, in some embodiments, the user device 102 may be configured with an indication dedicated for relaxed positioning measurement in the broadcast or dedicate signaling. The indication may indicates that the user device 102 may perform the relaxed positioning measurement only if the user device 102 satisfies both the low mobility and the UE-not-at-cell-edge criteria. Also, for at least some embodiments, the broadcast signaling may be a positioning SIB or a normal SIB (such as SIB2/3/4, etc.), and the dedicated signaling may be a RRC Release message. For at least some embodiments, if the indication is presented, the user device 102 may perform the relaxed positioning measurement when both UE-not-at-cell-edge and the low mobility criteria are satisfied.

In addition or alternatively, the user device 102 may reuse the normal-mobility state criteria configured in SIB2 for determination of the relaxed PRS configuration and relaxed positioning measurements. For at least some of the embodiments, the mobility state of the user device 102 may be determined if the parameters (T_{CRmax}, N_{CR_H}, N_{CR_M}, T_{CRmaxHyst} and cellEquivalentSize) are broadcasted in system information for the serving cell. In addition or alternatively, for at least some of these embodiments, state detection criteria may include normal-mobility state criteria, which may include: if a number of cell reselections during time period T_{CRmax} is less than N_{CR_M}, and if criteria for either Medium- or High-mobility state is not detected during a time period T_{CRmaxHyst}, then the user device 102 may enter Normal-mobility state.

In addition or alternatively, in some embodiments, the user device 102 may reuse the medium-mobility state criteria configured in SIB2 for determination of a relaxed PRS configuration and/or relaxed positioning measurements. In some of these embodiments, the mobility state of the user device 102 may be determined if the parameters (T_{CRmax}, N_{CR_H}, N_{CR_M}, T_{CRmaxHyst} and cellEquivalentSize) are broadcast in system information for the serving cell. In addition or alternatively, for at least some of these embodiments, state detection criteria may include medium-mobility state criteria, which may include: if a number of cell reselections during time period T_{CRmax} is greater than or equal to N_{CR_M} but less than or equal to N_{CR_H}, and if the criteria for Medium-mobility state is detected, the user device 102 may enter a medium-mobility state.

In addition or alternatively, in some embodiments, the user device 102 may reuse the stationary state criteria configured for a RedCap UE for determination of a relaxed PRS configuration and/or the relaxed positioning measurements. For at least some of these embodiments, the relaxed measurement criterion for a stationary RedCap UE is fulfilled when:

- (Srxlev_{RefStationary} − Srxlev) < S_{SearchDeltaP-Stationary},
Where:
- Srxlev = current Srxlev value of the serving cell (dB).
- Srxlev_{RefStationary} = reference Srxlev value of the serving cell (dB), set as follows:
- After selecting or reselecting a new cell, or
- If (Srxlev - Srxlev_{RefStationary}) > 0, or
- If the relaxed measurement criterion has not been met for T_{SearchDeltaP-Stationary}:
- Then the user device 102 shall set the value of Srxlev_{RefStationary} to the current Srxlev value
of the serving cell.
Srxlev_{RefStationary} and Srxlev may be measured based on SSB or PRS.

In addition or alternatively, in some embodiments, the user device 102 may reuse the stationary and not-at-cell-edge criteria configured for a RedCap UE for determination of a relaxed PRS configuration and/or the relaxed positioning measurements. For at least some of these embodiments, the relaxed measurement criterion for a stationary RedCap UE-not-at-cell-edge is fulfilled when:

- the relaxed measurement criterion in clause 5.2.4.9.3 is fulfilled for a period of T_{SearchDeltaP-Stationary},
- Srxlev > S_{SearchThresholdP2}, and,
- Squal > S_{SearchThresholdQ2}, if S_{SearchThresholdQ2} is configured.
Where:
- Srxlev = current Srxlev value of the serving cell (dB).
- Squal = current Squal value of the serving cell (dB).
Squal and Srxlev may be measured based on SSB or PRS.

In addition or alternatively, in some embodiments, for the relaxed PRS measurement, the signal intensity level is determined by the user device 102 measuring the PRS of its current camping cell or per TRP 208. The relaxed PRS measurement may include at least one of: PRS-RSRP, PRS-RSRQ, or PRS-RSRPP. In addition or alternatively, the user device 102 may measure at least A PRS samples of B PRS resources in the camping cell or per TRP 208, and the user device 102 may perform weighted average on these PRS measurements and derive the PRS measurement of the cell or the TRP 208 in order to perform the corresponding relaxed PRS measurement. For at least some of these embodiments, A and/or B may be predefined or explicit signaling from the at least one network device.

In other embodiments, the user device 102 may measure at least A PRS samples of B PRS resources in the camping cell or per TRP 208 within a time period. The user device 102 may perform an average on these PRS measurements in this time period and derive the PRS measurement of the cell or the TRP 208 in order to perform the corresponding relaxed PRS measurement. For at least some of these embodiments, A, B, and/or the time period may be predefined or explicit signaling from the at least one network device.

Also, for at least some embodiments, there may be several signal intensity levels, where each level is described as a power period with the unit of dBm (e.g., from x dBm to y dBm) or a single power value with the unit of dBm. In addition or alternatively, if the PRS measurement of the cell or the TRP 208 is within the certain power period, then the user device 102 may determine that it satisfies the certain intensity level of the relaxed PRS measurement.

In addition or alternatively, for at least some embodiments, the relaxed PRS configurations include at least one of:
a plurality of PRS resources within a plurality of selected TRPs 208, such as the first Ath TRPs 208 in a nr-DL-PRS-AssistanceDataPerFreq list, or the first Ath TRPs 208 in ae nr-SelectedDL-PRS-IndexListPerFreq for downlink time difference of arrival (DL-TDOA), downlink angle of departure (DL-AoD), and/or multi-round-trip time (RTT) positioning method;
a plurality of PRS resources within a plurality of selected cells, where, for example, the user device 102 only receives and measures the PRSs from the selected cells and ignores the other cells' PRS;
a plurality of PRS resources within a plurality of selected PRS frequency layers, such as the first Bth PFLs in a nr-DL-PRS-AssistanceDataList list, or a first Bth PFLs in a NR-SelectedDL-PRS-IndexList for DL-TDOA, DL-AOD and/or multi-RTT positioning method;
one or more selected PRS resource sets, such as the first Cth PRS resource sets in a nr-DL-PRS-ResourceSetList list, or the first Cth PRS resource sets in the dl-SelectedPRS-ResourceSetIndexList for DL-TDOA, DL-AoD and/or multi-RTT positioning method;
one or more selected PRS resources, such as the first Dth PRS resources in a dl-PRS-ResourceList list, or the first Dth PRS resources in the dl-SelectedPRS-ResourceIndexList for DL-TDOA, DL-AoD and/or multi-RTT positioning method;
a plurality of PRS resources within a selected PRS reception window in a RRC inactive state (e.g., RRC INACTIVE), which may be configured for user devices that support relaxed positioning and/or PRS measurements, and the number of which may be reduced, the periodicity of which may be increased, and/or the duration of which may be reduced;
a plurality of PRS resources including one or more PRS symbols that are reduced or decreased, for example, one symbol of a PRS that is dedicated for a relaxed PRS configuration;
a plurality of PRS resources including a PRS bandwidth that is reduced or decreased, such as, for example, the maximum bandwidth may be smaller than 63 physical resource blocks (PRBs) for a relaxed PRS configuration;
a plurality of PRS resources including a PRS comb size that is larger or increased, such as, for example, a PRS comb size that is larger than 12 for a relaxed PRS configuration;
a plurality of PRS resources including a PRS periodicity that is larger or increased, such as, for example, for a subcarrier spacing (SCS) of 15 kHz, the PRS periodicity may include 20480 milliseconds (ms) for a relaxed PRS configuration; and/or the larger or increased PRS periodicity may be calculated by multiplying an original, initial, or another PRS periodicity for a PRS resource and/or PRS resource set (e.g., used for a non-relaxed PRS measurement) by a factor that is larger than 1 (the factor may be explicitly indicated by the wireless access node 104 or may be a pre-defined value, in any of various embodiments);
a plurality of PRS resources including a PRS repetition factor that is reduced or decreased, such as, for example, the maximum repetition factor may be smaller than 2/4/5/8/16/32 for the relaxed PRS configuration, or the relaxed PRS configuration may not support PRS repetition.

Additionally, in some embodiments, the signaling of a relaxed PRS configuration may be that, a new information element (IE) includes a relaxed PRS configuration. In some of these embodiments, the IE may also include the corresponding condition, if any, in the relaxed PRS configuration. In addition or alternatively, each relaxed PRS configuration may be associated with each item in LPP signaling.

Additionally, for at least some embodiments, the signaling may be communicated between network devices of the wireless access node 104 (e.g., between one or more RAN nodes 204, a gNB 206 and/or a TRP 208, and the LMF 202), and/or between one or more network devices of the wireless access node 104 and a user device 102, to support or support relaxed positioning measurement. For at least some of these embodiments, the LMF 202 may request a RAN node 204 to provide one or more relaxed PRS configurations, each for a corresponding, different condition. In addition or alternatively, the RAN node 204 may respond to the request of the LMF 202 by including the one or more relaxed PRS configurations for the one or more different conditions. In addition or alternatively, the LMF 202 may send one or more relaxed PRS configurations corresponding to one or more different conditions to the user device 102, such as via LPP signaling. In addition or alternatively, the LMF 202 may send one or more relaxed PRS configurations of all TRPs 208 to a serving RAN node 204(e.g., a last serving RAN node 204). In turn, the (last) serving NG-RAN node 204 may send the one or more relaxed PRS configurations to the user device 102, such as via broadcast signaling or DL RRC signaling. In addition or alternatively, at least one network device, such as the LMF 202 or a gNB 206, may request the user device 102 to report the condition that the user device 102 currently satisfies. In addition or alternatively, the user device 102 may request the at least one network device, such as the LMF 202 or a gNB 206, for a relaxed PRS configuration in order to perform a relaxed positioning measurement. In addition or alternatively, the at least one network device, such as the LMF 202 or a gNB 206, may send a trigger indication to trigger the user device 102 to perform a relaxed positioning measurement. In addition or alternatively, the user device 102 may report, to at least one network device, such as the LMF 202 or a gBN, a capability of whether the user device 102 can support a judgement of the different conditions, such as a capability of whether the user device 102 can determine whether it can satisfy one or more of the different conditions. In addition or alternatively, the user device 102 may report to at least one network device, such as the LMF 202 or a gNB 206, a capability of whether the user device 102 can support performing a relaxed positioning measurement or a relaxed PRS configuration.

Additionally, in some embodiments, if a user device 102 satisfies one or more conditions, the user device 102 may perform a relaxed radio resource management (RRM) measurement. The one or more conditions may include at least one of:

The user device 102 is configured with a specific parameter of low mobility criteria, and the user device 102 may measure a SSB and satisfy the low mobility criteria;

The user device 102 may be configured with a specific parameter of UE-not-at-cell-edge criteria, and the user device 102 may measure a SSB and satisfy the UE-not-at-cell-edge criteria; or

The user device 102 may be configured with an indication that when both the low mobility criteria and the UE-not-at-cell-edge criteria are satisfied, the user device 102 may perform a relaxed RRM measurement, and/or where the user device 102 is configured with the specific parameters of both the low mobility criteria and the UE-not-at-cell-edge criteria, the user device 102 may measure a SSB and find that it satisfies both criteria.

For at least some embodiments where the user device 102 performs a relaxed RRM measurement in response to one or more conditions, the user device 102 may utilize power saving while perform positioning, for example, a LPHAP user device.

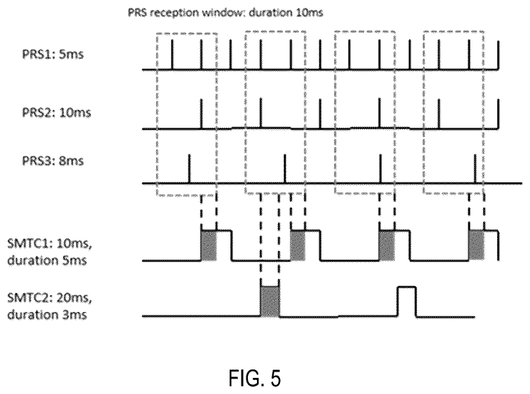

Additionally, in some embodiments, the user device 102 may perform a relaxed RRM measurement by reducing a SSB, which may save the user device's power. To further reduce the SSB reception in the RRC idle state (e.g., RRC_IDLE) or in the RRC inactive state (e.g., RRC_INACTIVE), especially where the user device 102 may need power saving while performing positioning, under some conditions, the user device 102 may measure SSB only in the time when the corresponding SSB measurement timing configuration (SMTC) and PRS reception window overlap. For example, the user device 102 may be configured with inter-frequency cell measurement for cell-reselection in system information block type 4 (SIB4), and each SMTC is configured with each center frequency of a SS block of the neighbor cells. At the same time, the user device 102 may be triggered with a positioning service and a PRS reception window is configured for the RRC inactive (e.g., RRC_INACTIVE) state and/or the RRC idle (RRC_IDLE) state. In turn, the user device 102 may only receive and measure PRS inside the PRS reception window. Under some conditions, the user device 102 may not need to perform frequent RRM measurement. Under such conditions, the user device 102 may further receive and measure the SSB only in the time when the corresponding SMTC and PRS reception window overlap. FIG. 5 is a timing diagram showing an example overlap of SMTC and a PRS reception window. Correspondingly, there may be two dropping situations. In a first situation, a certain time duration within a signal SMTC, like SMTC1 in FIG. 5, may be dropped, or certain SMTC instances (in the periodicity of a SMTC), like SMTC2 in FIG. 5, may be dropped.

Further referring to FIG. 5, in some embodiments, a user device 102 may measure SSB only in or during the time when the corresponding SMTC and PRS reception window overlap in response to one or more second conditions. For at least some embodiments, the one or more second conditions may include at least one of: low mobility criteria; UE-not-at-cell-edge-criteria; the user device 102 is a LPHAP user device; the user device 102 is on a positioning service, and/or the user device is receiving and/or measuring PRSs from the TRPs 208; the user device 102 supports the relaxed RRM measurement; the user device 102 is in the RRC inactive (e.g., RRC_INACTIVE) state; the user device is in the RRC idle (e.g., RRC_IDLE) state; or the user device is in a RRC connected (e.g., RRC_CONNECTED) state.

Additionally, in some embodiments, in event that the user device 102 satisfies a condition, the user device 102 may perform a relaxed sounding reference signal (SRS) transmission according to a relaxed SRS transmission rule. The relaxed SRS transmission rule may include at least one relaxed SRS configuration, which, at least in some embodiments, may be configured from at least one network device, such as the LMF 202 or a gNB 206. In some embodiments, the at least one relaxed SRS configuration may be configured via at least one of dedicated LPP or RRC signaling, or via RRC broadcast signaling. In other embodiments, the relaxed SRS transmission rule may be part of a standard or specification according to which the user device is configured to operate or follow. For such other embodiments, the relaxed SRS transmission rule may be, or may be part of, one or more pre-defined relax rules.

Additionally, in some embodiments, the user device 102 may be configured with a SRS configuration for positioning via RRC signaling to perform uplink time difference of arrival (UL-TDOA), uplink angle of arrival (UL-AoA) and multi-round trip time (RTT) positioning. Also, in some embodiments, when the user device 102 is in the RRC connected (e.g., RRC_CONNECTED) state, the SRS configuration may be provided in a SRS-Config in a bandwidth part (BWP)-UplinkDedicated IE. Also, in the RRC inactive (e.g., RRC_INACTIVE) state, the SRS configuration may be provided in a srs-PosRRC-Inactive in SuspendConfig in a RRC Release message.

Additionally, in some embodiments, at least one network device (e.g., a gNB 206) may configure a plurality of different relaxed SRS configuration, each corresponding to different one of a plurality of conditions. If the user device 102 satisfies a condition, the user device 102 may adopt the corresponding relaxed SRS configuration, and may sends the SRS according to the corresponding relaxed SRS configuration. In some embodiments, the at least one network device (e.g., a gNB 206) may send a corresponding relaxed SRS configuration via a dedicated DL RRC message (such as RRC Release message) or a broadcast (such as a positioning SIB).

Additionally, in some embodiments, at least one network device (e.g., the LMF 202 or a gNB 206) may configure a timer or time duration associated with a condition. If the user device 102 satisfies a condition before the timer expires (ends) or during the time duration, then the user device 102 may adopt the corresponding relaxed SRS configuration, and may send the SRS according to the relaxed SRS configuration. In other embodiments, the timer or time duration may be pre-defined or preconfigured with the user device 102, such that the timer or time duration is not configured via explicit signaling.

Additionally, in some embodiments, at least one network device (e.g., the LMF 202 or a gNB 206) may configure a validity area associated with a condition. If the user device 102 satisfies a condition within the validity area, the user device 102 may adopt the corresponding relaxed SRS configuration, and send the SRS according to the relaxed SRS configuration. In some embodiments, a validity area may include a list of cells. In addition or alternatively, a validity area may be dedicated for a relaxed SRS configuration, or the validity area for a SRS transmission in a RRC inactive state (e.g., RRC_INACTIVE) may be reused for the SRS transmission according to the relaxed SRS configuration.

Additionally, in some embodiments, the user device 102 may report a condition that it satisfies to at least one network device (e.g., the LMF 202 or a gNB 206). In response, the at least one network device (e.g., the gNB 206) may send a corresponding relaxed SRS configuration to the user device. The user device 102 may adopt the corresponding relaxed SRS configuration, and may send the SRS according to the relaxed SRS configuration.

Additionally, in some embodiments, the user device 102 may be configured with a timer, a time duration, and/or a validity area from at least one network device, and in turn, the user device 102 may monitor for the condition before the timer expires, during the time duration, and/or in the validity area. In other embodiments, the timer/time duration may be pre-defined or preconfigured with the user device 102, such that the user device 102 is not configured with the timer/time duration via explicit signaling. For such embodiments, the user device 102 may report the timer/time duration associated with a condition, which indicates that the user device 102 is to satisfy the condition until the timer ends or within the time duration. In addition or alternatively, the validity area may be pre-defined or preconfigured with the user device 102, such that the user device 102 is not configured with the validity area via explicit signaling. For such embodiments, the user device 102 may report a validity area associated with a condition, which indicates that the user device 102 is to satisfy the condition within the validity area. In some embodiments, the validity area may include a list of cells or a list of TRPs 208.

Additionally, in some embodiments, if the user device 102 satisfies one or more conditions, the user device 102 may perform a relaxed SRS transmission according to one or more pre-defined relax rules. The pre-defined rules may include at least one of the relaxed SRS configuration that the user device 102 is to adopt. Also, in any of various embodiments, different condition may correspond to different pre-defined relax rules. In some embodiments, the pre-defined rules may be associated with, or include a timer or time duration, and the user device 102 is to send the SRS according to the relaxed SRS configuration within the timer/time duration. In addition or alternatively, in some embodiments, the pre-defined relax rules may be associated with a validity area for the user device 102 to send the SRS according to the relaxed SRS configuration within the validity area. In some embodiments, the validity area may include a list of cells or a list of TRPs 208.

Additionally, in some embodiments, the one or more conditions may include at least one of: low mobility criteria; UE-not-at-cell-edge-criteria; medium-mobility state criteria; normal-mobility state criteria; stationary criteria; stationary not-at-cell-edge criteria; the user device 102 is in a certain signal intensity level; the user device is a LPHAP user device; the user device 102 supports the relaxed SRS configuration; the user device 102 supports to send the SRS according to the relaxed SRS configuration; the user device 102 is in a RRC inactive (e.g., RRC_INACTIVE) state; the user device 102 is in a RRC idle (e.g., RRC_IDLE) state; or the user device 102 is in a RRC connected (e.g., RRC_CONNECTED) state

Accordingly, the one or more conditions that the user device 102 may satisfy may be only a single condition, or a combination of two or more conditions. As non-limiting examples, one or more conditions that the user device 102 may judge to be satisfied may be: the user device 102 satisfies low mobility criteria but not UE-not-at-cell-edge criteria; the user device 102 satisfies UE-not-at-cell-edge criteria but not low mobility criteria; the user device 102 satisfies low mobility criteria and UE-not-at-cell edge criteria; the user device 102 does not satisfy low mobility criteria and UE-not-at-cell-edge criteria; the user device 102 satisfies the low mobility criteria and satisfies a certain signal intensity level; the user device 102 satisfies the UE-not-at-cell-edge-criteria and satisfies a certain signal intensity level; the user device 102 satisfies the low mobility criteria, the UE-not-at-cell-edge criteria, and a certain signal intensity level.

Additionally, in some embodiments, the user device 102 may reuse the low mobility criteria configured for a RRM relax measurement in a SIB2 in order to determine whether it should send the SRS according to the relaxed SRS configuration. In particular of these embodiments, at least one network device (e.g., a gNB 206) may configure lowMobilityEvaluation containing s-SearchDeltaP and t-SearchDeltaP, and the relaxed measurement criterion for the user device 102 with low mobility may be fulfilled when:

- (Srxlev_{Ref} - Srxlev) < S_{SearchDeltaP},
Where:
- Srxlev = current Srxlev value of the serving cell (dB).
- SrxlevRef = reference Srxlev value of the serving cell (dB), set as follows:
- After selecting or reselecting a new cell, or
- If (Srxlev - Srxlev_{Ref}) > 0, or
- If the relaxed measurement criterion has not been met for T_{SearchDeltaP}:
The user device 102 may set the value of SrxlevRef to the current Srxlev value of the serving
cell.
In some embodiments, Srxlev_{Ref} and Srxlev may be measured based on SSB or PRS.

In other embodiments, at least one network device (e.g., a gNB 206) may configure parameters of low mobility criteria dedicated for sending the SRS according to the relaxed SRS configuration, and may notify the user device 102 in the broadcast or dedicate signaling. In some embodiments, the broadcast signaling may be a positioning SIB or a normal SIB (such as SIB2/3/4, etc), and the dedicated signaling may be a RRC Release or a RRC Reconfiguration message. In particular of these embodiments, at least one network device (e.g., a gNB 206) may configure a threshold A (similar as s-SearchDeltaP) for sending the SRS according to the relaxed SRS configuration and a threshold B (similar as t-SearchDeltaP) for sending the SRS according to the relaxed SRS configuration. The judgment rule may be the same as previously described. Also, for at least some embodiments, the threshold A and the threshold B for sending the SRS according to the relaxed SRS configuration, maybe the same as, and/or in the same information element (IE) as, the threshold A and threshold B for the relaxed positioning measurement according to the relaxed PRS configuration, as previously described.

Additionally, in some embodiments, the user device 102 may reuse the UE-not-at-cell-edge criteria configured for a RRM relax measurement in SIB2, in order to determine whether it should send the SRS according to the relaxed SRS configuration. In particular embodiments, at least one network device (e.g., a gNB 206) may configure cellEdgeEvaluation including s-SearchThresholdP and s-SearchThresholdQ, and the UE-not-at-cell-edge criteria may be fulfilled when:

- Srxlev > S_{SearchThresholdP}, and,
Squal > S_{SearchThresholdQ}, if S_{SearchThresholdQ} is configured,
Where:
- Srxlev = current Srxlev value of the serving cell (dB).
- Squal = current Squal value of the serving cell (dB).
Also, Squal and Srxlev may be measured based on SSB or PRS.

In other embodiments, at least one network device (e.g., a gNB 206) may configures parameters of the UE-not-at-cell-edge criteria dedicated for sending the SRS according to the relaxed SRS configuration, and may notify the user device 102 in the broadcast or dedicated signaling. In some embodiments, the broadcast signaling may be a positioning SIB or a normal SIB (such as SIB2/3/4, etc.). In addition or alternatively, the dedicated signaling may be a RRC Release or a RRC Reconfiguration message. In particular of these embodiments, at least one network device (e.g., a gNB 206) may configure a threshold C (similar as s-SearchThresholdP) for relaxed positioning measurement and a threshold D (similar as s-SearchThresholdQ) for sending the SRS according to the relaxed SRS configuration. Also, the judgment rule may be the same as previously described. Also, in some embodiments, the threshold C and/or the threshold D for sending the SRS according to the relaxed SRS configuration, may be the same as, or in the same IE as, the threshold C and/or threshold D for relaxed positioning measurement as previously described.

Additionally, in some embodiments, the user device 102 may reuse a combined indication (e.g., combineRelaxedMeasCondition indication in SIB2) for a RRM relax measurement in order to determine whether to send the SRS according to the relaxed SRS configuration. In some embodiments, the combined indication may be in an IE that configures the user device 102 to fulfil both the low mobility criteria and the UE-not-at-cell-edge criteria in order to determine relax measurement requirements for cell reselection. If the IE is, and/or is set to, a certain value (e.g., a value corresponding to Boolean TRUE), the user device 102 may send the SRS according to the relaxed SRS configuration when both the UE-not-at-cell-edge and the low mobility criteria are satisfied.

Additionally, in some embodiments, the user device 102 may be configured with an indication dedicated for sending the SRS according to the relaxed SRS configuration in broadcast or dedicated signaling. In some embodiments, the broadcast signaling may be a positioning SIB or a normal SIB (such as SIB2/3/4, etc), and the dedicated signaling may be a RRC Release message. If the indication is presented, the user device 102 may send the SRS according to the relaxed SRS configuration when both the UE-not-at-cell-edge and the low mobility criteria are satisfied. Also, in some embodiments, the dedicated indication for sending the SRS according to the relaxed SRS configuration may be the same as, and/or in the same IE as, the dedicated indication for relaxed positioning measurement as previously described.

Additionally, in some embodiments, the user device 102 may reuse normal-mobility state criteria configured in SIB2 in order to determine whether it should send the SRS according to the relaxed SRS configuration. In particular embodiments, the normal mobility state may be determined if the parameters (T_{CRmax}, N_{CR_H}, N_{CR_M}, T_{CRmaxHyst} and cellEquivalentSize) are broadcasted in system information for the serving cell. Also, in some embodiments, state detection criteria may include normal-mobility state criteria, which may include: if a number of cell reselections during a time period T_{CRmax} is less than N_{CR_M}, and if criteria for either a Medium-mobility state or a High-mobility state is not detected during time period T_{CRmaxHyst}, then the user device 102 may enter the Normal-mobility state.

Additionally, in some embodiments, the user device 102 may reuse the medium-mobility state criteria configured in SIB2 in order to determine whether it should send the SRS according to the relaxed SRS configuration. In particular of these embodiments, the mobility state of the user device 102 may be determined if the parameters (T_{CRmax}, N_{CR_H}, N_{CR_M}, T_{CRmaxHyst} and cellEquivalentSize) are broadcasted in system information for the serving cell. Also, in some embodiments, state detection criteria may include medium-mobility state criteria, which may include: if a number of cell reselections during time period T_{CRmax} is greater than or equal to N_{CR_M} but less than or equal to N_{CR_H}, and if the criteria for Medium-mobility state is detected, then the user device 102 may enter the Medium-mobility state.

Additionally, in some embodiments, the user device 102 may reuse the stationary state criteria configured for a RedCap user device for determination of a relaxed PRS configuration and relaxed positioning measurements. In particular of these embodiments, the relaxed measurement criterion for a stationary RedCap UE is fulfilled when:

- (Srxlev_{RefStationary} − Srxlev) < S_{SearchDeltaP-Stationary},
Where:
- Srxlev = current Srxlev value of the serving cell (dB).
- Srxlev_{RefStationary} = reference Srxlev value of the serving cell (dB), set as follows:
- After selecting or reselecting a new cell, or
- If (Srxlev - Srxlev_{RefStationary}) > 0, or
- If the relaxed measurement criterion has not been met for T_{SearchDeltaP-Stationary}:
- The UE shall set the value of Srxlev_{RefStationary} to the current Srxlev value of the serving cell.
Also, in some embodiments, Srxlev_{RefStationary} and Srxlev may be measured based on SSB or
PRS.

Additionally, in some embodiments, the user device 102 may reuse the stationary and not-at-cell-edge criteria configured for a RedCap UE for determination of a relaxed PRS configuration and relaxed positioning measurements. In particular of these embodiments, the relaxed measurement criterion for a stationary RedCap UE-not-at-cell-edge is fulfilled when:

- the relaxed measurement criterion is fulfilled for a period of T_{SearchDeltaP-Stationary},
- Srxlev > S_{SearchThresholdP2}, and,
- Squal > S_{SearchThresholdQ2}, if S_{SearchThresholdQ2} is configured.
Where:
- Srxlev = current Srxlev value of the serving cell (dB).
- Squal = current Squal value of the serving cell (dB).
Also, Squal and Srxlev may be measured based on SSB or PRS.

Additionally, in some embodiments, for relaxed SRS transmission, the signal intensity level may be determined by a TRP 208 measuring SRS of the user device. The measurement may include at least one of: UL SRS-reference signal received power (RSRP), UL SRS-reference signal received quality (RSRQ), UL SRS-reference signal received path power (RSRPP). In some of these embodiments, the TRP 208 may measures at least C SRS samples of D SRS resources of the user device 102, and at least one network device (e.g., a TRP 208 or a gNB 206) may perform weighted average on these UL SRS measurements and derive the UL SRS measurement of the user device 102 in order to perform the corresponding relaxed SRS transmission. Additionally, in any of various embodiments, A or B are pre-defined or preconfigured with the user device 102, or are determined via explicit signaling from the at least one network device.

In other embodiments, a TRP 208 may measure at least C SRS samples of D SRS resources of the user device within a time period, and at least one network device (e.g., the TRP 208 or a gNB 206) may perform an average on these UL SRS measurements within the time period and derive the UL SRS measurement of the user device 102 in order to perform a corresponding relaxed SRS transmission. In any of various embodiments, A, B and/or the time period may be pre-defined or preconfigured with the user device 102, or may be determined via explicit signaling from the at least one network device.

Additionally, in some embodiments, the UL SRS measurement of the TRP 208 may be sent to the LMF 202. In addition, in some of these embodiments, the LMF 202 may request the UL SRS measurement first, and then the LMF 202 may trigger the user device 102 to perform relaxed SRS transmission, or the gNB 206 may trigger the user device 102 to perform the relaxed SRS transmission directly. In addition or alternatively, the user device 102 may request to perform the relaxed SRS transmission.

Additionally, in some embodiments, there are several signal intensity levels, where each level is, or is characterized as, a power range with the unit of dBm (e.g., from x dBm to y dBm) or a single power value with the unit of dBm.

Additionally, in some embodiments, if larger than C (or the largest C) TRPs 208 that receive the user device's SRS measurement, and the UL SRS measurement of the user device 102 is within the certain power range, then at least one network device may notify the user device 102, and in turn, the user device 102 may determine that it satisfies the certain intensity level of the relaxed SRS transmission. Also, in any of various embodiments, C is an integer greater than or equal to 1. In addition or alternatively, C is a threshold and can be determined and/or indicated by the LMF 202 or a gNB 206.

Additionally, in some embodiments, if a weighted average (with a weighted factor equal to 1, or other values) of UL SRS measurements of the user device 102 from D TRPs 208 is within a certain power range, then at least one network device may notify the user device 102, and the user device 102 may determine that it satisfies the corresponding certain intensity level of relaxed SRS transmission. Additionally, in any of various embodiments, D is an integer greater than or equal to 1, and/or D is a threshold and can be determined and/or indicated by the LMF 202 or a gNB 206.

Additionally, in some embodiments, one or more relaxed SRS configurations may include at least one of:
a plurality of selected SRS resource sets, such as, for example, where the number of SRS resource sets is an integer x;
a plurality of selected SRS resources, such as, for example, where the number of SRS resources is an integer y;
a plurality of SRS resources including a transmission comb size that is larger or increased, such as, for example, where the minimum transmission comb size for a relaxed SRS configuration is larger than n2/n4/n8;
a plurality of SRS resources including a SRS periodicity that is larger or increased, such as, for example, where the minimum periodicity for a relaxed SRS configuration is larger than
   1/2/4/5/8/10/16/20/32/40/64/80/160/320/640/1280/2560/5120/10240/40960/81920 milliseconds (ms); or, the larger or increased periodicity is determined by multiplying an original, initial, or another SRS periodicity (e.g., one used for a non-relaxed SRS transmission) by a factor larger than 1 (the factor may be explicitly indicated by the wireless access node 104 or may be a pre-defined value, in any of various embodiments);
a plurality of SRS resources including a larger SRS validity area, such as, for example, where the validity area includes a plurality of cells in which the user device 102 can send a pre-configured SRS, and/or where the validity area includes more cells in which the user device 102 can send the pre-configured SRS dedicated for a relaxed SRS configuration, compared to other SRS validity areas configured in a RRC inactive state (e.g., RRC_INACTIVE); or
a plurality of SRS resources including a SRS transmission power that is lower or reduced, such that at least alpha and/or a p0 value are differentiated.

Also, in some embodiments, an IE may be used to indicate the relaxed SRS configuration. In some of these embodiments, the signaling of a relaxed SRS configuration can be that, an IE includes a relaxed SRS configuration, and in some embodiments may further include the corresponding condition, if any). In other of these embodiments, the relaxed SRS configuration is associated with each item in RRC signaling.

Additionally, in some embodiments, network devices (e.g., the LMF 202, one or more RAN nodes 204, one or more gNBs 206, and/or one or more TRPs 208) may communicate (transmit and receive) signaling between each other, and/or at least one network device and a user device 102 may communicate (transmit and receive) signaling to support the user device 102 sending the SRS according to a relaxed SRS configuration. The communicate may include that the LMF 202 requests a RAN node 204 to trigger a relaxed SRS configuration, e.g., for different conditions. In addition or alternatively, the LMF 202 may request the RAN node 204 to configure or update a relaxed SRS configuration, e.g., for different conditions. In response, the RAN node 204 may send the relaxed SRS configuration to the LMF 202, and/or may update the relaxed SRS configuration. In addition or alternatively, the LMF 202 may send one or more TRPs 208, or update one or more TRPs 208 with, the relaxed SRS configuration. In addition or alternatively, at least one network device (e.g., the LMF 202 or a gNB 206) may request the user device 102 to report the condition that the user device 102 currently satisfies. In addition or alternatively, the user device 102 may request at least one network device (e.g., the LMF 202 or a gNB 206) for a relaxed SRS configuration. In addition or alternatively, at least one network device e.g., (e.g., the LMF 202 or gNB 206) may send a trigger indication to trigger the user device 102 to send the SRS according to the relaxed SRS configuration. In addition or alternatively, the user device 102 may report the relaxed SRS configuration that it used during a previous time or instance. In addition or alternatively, the user device 102 may report a capability to at least one network device (e.g., the LMF 202 or gNB 206) on whether it can support a judgement of the different conditions, such as whether the user device 102 is capable of determining whether it satisfies one or more of the different conditions. In addition or alternatively, the user device 102 may report a capability to at least one network device (e.g., the LMF 202 or gNB 206) on whether it can support sending the SRS according to the relaxed SRS configuration.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: determining, by a user device, that the user device satisfies a condition; and in response to satisfying the condition, at least one of: performing, by the user device, a relaxed positioning reference signal (PRS) measurement according to a relaxed PRS measurement rule that corresponds to the condition; or performing, by the user device, a relaxed sounding reference signal (SRS) transmission according to a relaxed SRS transmission rule that corresponds to the condition.

A second aspect includes the first aspect, and further includes wherein the relaxed PRS measurement rule includes a relaxed PRS configuration configured by at least one network device, wherein the relaxed PRS configuration is received by the user device in at least one of a broadcast signaling or a signaling dedicated for the user device.

A third aspect includes any of the first or second aspects, and further includes wherein the relaxed PRS measurement rule comprises a relaxed PRS configuration that is pre-defined.

A fourth aspect includes any of the first through third aspects, and further includes wherein the relaxed SRS transmission rule comprises a relaxed SRS configuration configured by at least one network device, wherein the relaxed SRS configuration is received by the user device in at least one of a broadcast signaling or a signaling dedicated for the user device.

A fifth aspect includes any of the first through fourth aspects, and further includes wherein the relaxed SRS transmission rule comprises a relaxed SRS configuration that is pre-defined.

A sixth aspect includes any of the first through fifth aspects, and further includes: performing, by the user device, at least one of the relaxed PRS measurement or the relaxed SRS transmission, within a first time period.

A seventh aspect includes any of the first through sixth aspects, and further includes performing, by the user device, at least one of the relaxed PRS measurement or the relaxed SRS transmission, within a first validity area.

An eighth aspect includes the seventh aspect, and further includes wherein the first validity area includes at least one of: a list of cells or a list of transmission reception points (TRPs).

A ninth aspect includes any of the first through eighth aspects, and further includes: transmitting, by the user device, to at least one network device, at least one of: a first indication that the user device has satisfied the condition or the condition that the user device satisfies.

A tenth aspect includes any of the first through ninth aspects, and further includes wherein the condition comprises at least one of: low mobility criteria, UE-not-at-cell-edge criteria, stationary criteria, stationary not-at-cell-edge criteria, the user device is in a signal intensity level, the user device supports the relaxed PRS measurement, the user device supports the relaxed SRS transmission, the user device is in a radio resource control (RRC) inactive state, or the user device is in a RRC idle state.

An eleventh aspect includes the tenth aspect, and further includes wherein the low mobility criteria is configured for a radio resource management (RRM) relaxed measurement, the method further comprising: using, by the user device, the low mobility criteria in order to determine whether to perform at least one of: the relaxed PRS measurement or the relaxed SRS transmission.

A twelfth aspect includes the eleventh aspect, and further includes: receiving, by the user device, one or more parameters of the low mobility criteria dedicated for at least one of the relaxed PRS measurement or the relaxed SRS transmission from at least one network device.

A thirteenth aspect includes any of the tenth through twelfth aspects, and further includes wherein the UE-not-at-cell-edge criteria is configured for a radio resource management (RRM) relaxed measurement, and using, by the user device, the UE-not-at-cell-edge criteria in order to determine whether to perform at least one of: the relaxed PRS measurement or the relaxed SRS transmission.

A fourteenth aspect includes the thirteenth aspect, and further includes: receiving, by the user device, one or more parameters of the UE-not-at-cell-edge criteria dedicated for at least one of the relaxed PRS measurement or the relaxed SRS transmission from at least one network device.

A fifteenth aspect includes any of the tenth through fourteenth aspects, and further includes: performing, by the user device, at least one of the relaxed PRS measurement or the relaxed SRS transmission according to a combined indication for the low mobility criteria and the UE-not-at-cell-edge criteria that is used for a radio resource management (RRM) relaxed measurement.

A sixteenth aspect includes any of the tenth through fifteenth aspects, and further includes: receiving, by the user device, a second indication dedicated for at least one: the relaxed PRS measurement or the relaxed SRS transmission, wherein the indication is included in at least one of a broadcast signaling or a signaling dedicated for the user device; and in response to receiving the second indication, determining, by the user device, to perform at least one of the relaxed PRS measurement or the relaxed SRS transmission only when both the low mobility criteria and the UE-not-at-cell-edge criteria are satisfied.

A seventeenth aspect includes any of the tenth through sixteenth aspects, and further includes wherein the stationary criteria and the stationary not-at-cell-edge criteria are configured for a reduced capability (RedCap) user device, and using, by the user device, at least one of stationary criteria or the stationary not-at-cell-edge criteria in order to determine whether to perform at least one of: the relaxed PRS measurement or the relaxed SRS transmission.

An eighteenth aspect includes any of the tenth through seventeenth aspects, and further includes: determining, by the user device, that the user device is in a signal intensity level by comparing a PRS measurement of a cell or a transmission reception point (TRP) with a predefined signal intensity level, wherein: the PRS measurement of the cell or the TRP is determined by the weighted average of one or more PRS measurements, and the one or more PRS measurements is determined by measuring one or more PRS samples of one or more PRS resources within the cell or the TRP.

A nineteenth aspect includes the eighteenth aspect, and further includes wherein the one or more PRS samples is determined within a second time period.

A twentieth aspect includes any of the second through nineteenth aspects, wherein the relaxed PRS configuration comprises at least one of: a plurality of PRS resources; a plurality of PRS resource sets; a plurality of PRS resources that is within a plurality of transmission reception points (TRPs); a plurality of PRS resources that is within a plurality of cells; a plurality of PRS resources that is within a plurality of PRS frequency layers; a plurality of PRS resources that is within a selected PRS reception window; a plurality of PRS resources comprising a PRS symbol that is decreased; a plurality of PRS resources comprising a PRS bandwidth that is decreased; a plurality of PRS resources comprising a PRS comb size that is increased; a plurality of PRS resources comprising a PRS periodicity that is increased; or a plurality of PRS resources comprising a PRS repetition factor that is decreased.

A twenty-first aspect includes any of the second through twentieth aspects, and further includes wherein the relaxed SRS configuration comprises at least one of: a plurality of SRS resource sets; a plurality of SRS resources; a plurality of SRS resources comprising a SRS periodicity that is increased; a plurality of SRS resources that is within a SRS second validity area, wherein the SRS second validity area is dedicated for the relaxed SRS transmission; or a plurality of SRS resources comprising a SRS transmission power that is decreased.

A twenty-second aspect includes any of the first through twenty-first aspects, and further includes: receiving, by the user device, a request to report the condition that the user device satisfies.

A twenty-third aspect includes any of the second through twenty-second aspects, and further includes: transmitting, by the user device, a request to receive at least one of the relaxed PRS configuration or the relaxed SRS configuration.

A twenty-fourth aspect includes any of the first through twenty-third aspects, and further includes: receiving, by the user device, a third indication to trigger the user device to perform at least one of the relaxed PRS measurement according to the relaxed PRS measurement rule or the relaxed SRS transmission according to the relaxed SRS transmission rule.

A twenty-fifth aspect includes any of the first through twenty-fourth aspects, and further includes: transmitting, by the user device, a report of a capability of the user device to support a judgment of the condition.

A twenty-sixth aspect includes any of the first through twenty-fifth aspects, and further includes: transmitting, by the user device, a report of a capability of the user device to support performing at least one of: the relaxed PRS measurement according to the relaxed PRS measurement rule or the relaxed SRS transmission according to the relaxed SRS transmission rule.

A twenty-seventh aspect includes any of the first through twenty-sixth aspects, and further includes: in response to a second condition, measuring, by the user device, a synchronization signal block (SSB) only during a third time period that a corresponding SSB measurement timing configuration (SMTC) and a PRS reception window overlap.

A twenty-eight aspect includes the twenty-seventh aspect, and further includes wherein the second condition comprises at least one of: low mobility criteria; UE-not-at-cell-edge criteria; the user device supports a radio resource management (RRM) relaxed measurement; the user device is in a radio resource control (RRC) inactive state; or the user device is in a RRC idle state.

A twenty-ninth aspect includes a method for wireless communication that includes: determining, by at least one network device, a relaxed positioning reference signal (PRS) measurement rule corresponding to a first condition or a relaxed sounding reference signal (SRS) transmission rule corresponding to a second condition, wherein the relaxed PRS measurement rule comprises a relaxed PRS configuration and the relaxed SRS transmission rule comprises a relaxed SRS configuration; and transmitting, by the at least one network device, the relaxed PRS measurement rule corresponding to the first condition or the relaxed SRS transmission rule corresponding to the second condition, wherein the at least one network device comprises at least one of a location management function (LMF) or one or more radio access network (RAN) nodes.

A thirtieth aspect includes the twenty-ninth aspect, and further includes: configuring, by the at least one network device, a first time period during which the user device is to perform at least one of a relaxed PRS measurement according to the relaxed PRS measurement rule or a relaxed SRS transmission according to the relaxed SRS transmission rule.

A thirty-first aspect includes any of the twenty-ninth or thirtieth aspect, and further includes: configuring, by the at least one network device, a first validity area in which the user device is to perform at least one of a relaxed PRS measurement according to the relaxed PRS measurement rule or a relaxed SRS transmission according to the relaxed SRS transmission rule.

A thirty-second aspect includes the thirty-first aspect, and further includes wherein the first validity area comprises at least one of: a list of cells or a list of transmission reception points (TRPs).

A thirty-third aspect includes any of the twenty-ninth through thirty-second aspects, and further includes: receiving, by the at least one network device, at least one of: a first indication that the user device has satisfied the first condition or the second condition, or the first condition or the second condition that the user device satisfies.

A thirty-fourth aspect includes any of the twenty-ninth through thirty-third aspects, and further includes wherein at least one of the first condition or the second condition comprises at least one of: low mobility criteria, UE-not-at-cell-edge criteria, stationary criteria, stationary not-at-cell-edge criteria, the user device is in a signal intensity level, the user device supports the relaxed PRS measurement, the user device supports the relaxed SRS transmission, the user device is in a radio resource control (RRC) inactive state, or the user device is in a RRC idle state.

A thirty-fifth aspect includes the thirty-fourth aspect, and further includes: determining, by the at least one network device, one or more parameters of the low mobility criteria dedicated for the user device to perform at least one of the relaxed PRS measurement or the relaxed SRS transmission; and transmitting, by the at least one network device, the one or more parameters to the user device.

A thirty-sixth aspect includes any of the thirty-fourth or thirty-fifth aspects, and further includes: determining, by the at least one network device, one or more parameters of the UE-not-at-cell-edge criteria for the user device to perform at least one of the relaxed PRS measurement or the relaxed SRS transmission; and transmitting, by the at least one network device, the one or more parameters to the user device.

A thirty-seventh aspect includes any of the thirty-fourth through thirty-sixth aspects, and further includes: determining, by the at least one network device, a second indication dedicated for the user device to perform at least one of the relaxed PRS measurement or the relaxed SRS transmission; and transmitting, by the at least one network device, the second indication to indicate the user device to perform at least one of the relaxed PRS measurement or the relaxed SRS transmission only when both the low mobility criteria and the UE-not-at-cell-edge criteria are satisfied.

A thirty-eighth aspect includes any of the twenty-ninth through thirty-seventh aspects, and further includes wherein the relaxed PRS configuration comprises at least one of: a plurality of PRS resources; a plurality of PRS resource sets; a plurality of PRS resources that is within a plurality of transmission reception points (TRPs); a plurality of PRS resources that is within a plurality of cells; a plurality of PRS resources that is within a plurality of PRS frequency layers; a plurality of PRS resources that is within a selected PRS reception window; a plurality of PRS resources comprising a PRS symbol that is decreased; a plurality of PRS resources comprising a PRS bandwidth that is decreased; a plurality of PRS resources comprising a PRS comb size that is increased; a plurality of PRS resources comprising a PRS periodicity that is increased; or a plurality of PRS resources comprising a PRS repetition factor that is decreased.

A thirty-ninth aspect includes any of the twenty-ninth through thirty-eighth aspects, and further includes wherein the relaxed SRS configuration comprises at least one of: a plurality of SRS resource sets; a plurality of SRS resources; a plurality of SRS resources comprising a SRS periodicity that is increased; a plurality of SRS resources that is within a SRS second validity area, wherein the SRS second validity area is dedicated for the relaxed SRS transmission; or a plurality of SRS resources comprising a SRS transmission power that is decreased.

A fortieth aspect includes any of the twenty-ninth through thirty-ninth aspects, and further includes: requesting, by the LMF to the one or more RAN nodes, that the one or more RAN nodes trigger the user device to perform at least one of the relaxed PRS measurement or the relaxed SRS transmission.

A forty-first aspect includes any of the twenty-ninth through fortieth aspects, and further includes: requesting, by the at least one network device to the user device, that the user device perform at least one of the relaxed PRS measurement or the relaxed SRS transmission.

A forty-second aspect includes any of the twenty-ninth through forty-first aspects, and further includes: requesting, by the LMF to the one or more RAN nodes, that the one or more RAN nodes at least one of provide or update the relaxed PRS configuration or relaxed SRS configuration.

A forty-third aspect includes any of the twenty-ninth through forty-second aspects, and further includes: providing, by the one or more RAN nodes to the LMF, that at least one of the relaxed PRS configuration or relaxed SRS configuration.

A forty-fourth aspect includes any of the twenty-ninth through forty-third aspects, and further includes: requesting, by the at least one network device to the user device, to provide the first condition or the second condition that the user device satisfies.

A forty-fifth aspect includes any of the twenty-ninth through forty-fourth aspects, and further includes: receiving, by the at least one network device from the user device, a request to receive at least one of the relaxed PRS configuration or the relaxed SRS configuration.

A forty-sixth aspect includes any of the twenty-ninth through forty-fifth aspects, and further includes: receiving, by the at least one network device from the user device, a report of a capability of the user device to support a judgment of the first condition or the second condition.

A forty-seventh aspect includes any of the twenty-ninth through forty-sixth aspects, and further includes: receiving, by the at least one network device from the user device, a report of a capability of the user device to support performing at least one of the relaxed PRS measurement according to the relaxed PRS measurement rule or the relaxed SRS transmission according to the relaxed SRS transmission rule.

A forty-eighth aspect includes a wireless communications apparatus that includes a processor and a memory, wherein the processor is configured to read code from the memory to implement any of the first through forty-seventh aspects.

A forty-ninth aspect includes a computer program product comprising a computer-readable program medium comprising code stored thereupon, the code, when executed by a processor, causing the processor to implement any of the first through forty-seventh aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, by a user device, that the user device satisfies a condition; and
in response to satisfying the condition, at least one of:
performing, by the user device, a relaxed positioning reference signal (PRS) measurement according to a relaxed PRS measurement rule that corresponds to the condition; or
performing, by the user device, a relaxed sounding reference signal (SRS) transmission according to a relaxed SRS transmission rule that corresponds to the condition.

2. The method of claim 1, wherein the relaxed PRS measurement rule comprises a relaxed PRS configuration configured by at least one network device, wherein the relaxed PRS configuration is received by the user device in at least one of a broadcast signaling or a signaling dedicated for the user device.

3. The method of claim 1, wherein the relaxed PRS measurement rule comprises a relaxed PRS configuration or a relaxed SRS configuration that is pre-defined.

4. The method of claim 1, wherein the relaxed SRS transmission rule comprises a relaxed SRS configuration configured by at least one network device, wherein the relaxed SRS configuration is received by the user device in at least one of a broadcast signaling or a signaling dedicated for the user device.

5. The method of claim 1, further comprising:
performing, by the user device, at least one of the relaxed PRS measurement or the relaxed SRS transmission, within a first time period.

6. The method of claim 1, further comprising:
performing, by the user device, at least one of the relaxed PRS measurement or the relaxed SRS transmission, within a first validity area,
wherein the first validity area comprises at least one of: a list of cells or a list of transmission reception points (TRPs).

7. The method of claim 2, further comprising:
transmitting, by the user device, to at least one network device, at least one of: a first indication that the user device has satisfied the condition or the condition that the user device satisfies.

8. The method of claim 1, wherein the condition comprises at least one of:
low mobility criteria,
UE-not-at-cell-edge criteria,
stationary criteria,
stationary not-at-cell-edge criteria,
the user device is in a signal intensity level,
the user device supports the relaxed PRS measurement,
the user device supports the relaxed SRS transmission,
the user device is in a radio resource control (RRC) inactive state, or
the user device is in a RRC idle state.

9. The method of claim 8, wherein the low mobility criteria is configured for a radio resource management (RRM) relaxed measurement, the method further comprising:
using, by the user device, the low mobility criteria in order to determine whether to perform at least one of: the relaxed PRS measurement or the relaxed SRS transmission.

10. The method of claim 8, wherein the UE-not-at-cell-edge criteria is configured for a radio resource management (RRM) relaxed measurement, the method further comprising:
using, by the user device, the UE-not-at-cell-edge criteria in order to determine whether to perform at least one of: the relaxed PRS measurement or the relaxed SRS transmission.

11. The method of claim 8, further comprising:
performing, by the user device, at least one of the relaxed PRS measurement or the relaxed SRS transmission according to a combined indication for the low mobility criteria and the UE-not-at-cell-edge criteria that is used for a radio resource management (RRM) relaxed measurement.

12. The method of claim 8, further comprising:
receiving, by the user device, a second indication dedicated for at least one: the relaxed PRS measurement or the relaxed SRS transmission, wherein the indication is included in at least one of a broadcast signaling or a signaling dedicated for the user device; and
in response to receiving the second indication, determining, by the user device, to perform at least one of the relaxed PRS measurement or the relaxed SRS transmission only when both the low mobility criteria and the UE-not-at-cell-edge criteria are satisfied.

13. The method of claim 8, wherein the stationary criteria and the stationary not-at-cell-edge criteria are configured for a reduced capability (RedCap) user device, further comprising:
using, by the user device, at least one of stationary criteria or the stationary not-at-cell-edge criteria in order to determine whether to perform at least one of: the relaxed PRS measurement or the relaxed SRS transmission.

14. The method of claim 8, further comprising:
determining, by the user device, that the user device is in a signal intensity level by comparing a PRS measurement of a cell or a transmission reception point (TRP) with a predefined signal intensity level, wherein:
the PRS measurement of the cell or the TRP is determined by a weighted average of one or more PRS measurements, and
the one or more PRS measurements is determined by measuring one or more PRS samples of one or more PRS resources within the cell or the TRP.

15. The method of claim 2, wherein the relaxed PRS configuration comprises at least one of:
a plurality of PRS resources;
a plurality of PRS resource sets;
a plurality of PRS resources that is within a plurality of transmission reception points (TRPs);
a plurality of PRS resources that is within a plurality of cells;
a plurality of PRS resources that is within a plurality of PRS frequency layers;
a plurality of PRS resources that is within a selected PRS reception window;
a plurality of PRS resources comprising a PRS symbol that is decreased;
a plurality of PRS resources comprising a PRS bandwidth that is decreased;
a plurality of PRS resources comprising a PRS comb size that is increased;
a plurality of PRS resources comprising a PRS periodicity that is increased; or
a plurality of PRS resources comprising a PRS repetition factor that is decreased.

16. The method of claim 4, wherein the relaxed SRS configuration comprises at least one of:
a plurality of SRS resource sets;
a plurality of SRS resources;
a plurality of SRS resources comprising a SRS periodicity that is increased;
a plurality of SRS resources that is within a SRS second validity area, wherein the SRS second validity area is dedicated for the relaxed SRS transmission; or
a plurality of SRS resources comprising a SRS transmission power that is decreased.

17. The method of claim 2, further comprising:
transmitting, by the user device, a request to receive at least one of the relaxed PRS configuration or the relaxed SRS configuration.

18. The method of claim 1, further comprising at least one of:
receiving, by the user device, a third indication to trigger the user device to perform at least one of the relaxed PRS measurement according to the relaxed PRS measurement rule or the relaxed SRS transmission according to the relaxed SRS transmission rule;
transmitting, by the user device, a report of a capability of the user device to support a judgment of the condition;
transmitting, by the user device, a report of a capability of the user device to support performing at least one of: the relaxed PRS measurement according to the relaxed PRS measurement rule or the relaxed SRS transmission according to the relaxed SRS transmission rule; or
in response to a second condition, measuring, by the user device, a synchronization signal block (SSB) during a third time period that a corresponding SSB measurement timing configuration (SMTC) and a PRS reception window overlap.

19. A method for wireless communication, the method comprising:
determining, by at least one network device, a relaxed positioning reference signal (PRS) measurement rule corresponding to a first condition or a relaxed sounding reference signal (SRS) transmission rule corresponding to a second condition, wherein the relaxed PRS measurement rule comprises a relaxed PRS configuration and the relaxed SRS transmission rule comprises a relaxed SRS configuration; and
transmitting, by the at least one network device, the relaxed PRS measurement rule corresponding to the first condition or the relaxed SRS transmission rule corresponding to the second condition,
wherein the at least one network device comprises at least one of a location management function (LMF) or one or more radio access network (RAN) nodes.

20. A wireless communications apparatus comprising:
a memory storing a plurality of instructions; and
at least one processor configured to execute the plurality of instructions, and upon execution of the plurality of instructions, is configured to:
determine that the user device satisfies a condition; and
in response to satisfying the condition, at least one of:
perform a relaxed positioning reference signal (PRS) measurement according to a relaxed PRS measurement rule that corresponds to the condition; or
perform a relaxed sounding reference signal (SRS) transmission according to a relaxed SRS transmission rule that corresponds to the condition.
